(19) United States
(12) Patent Application Publication
(10) Pub. No.: US 2016/0292640 A1
(43) Pub. Date: Oct. 6, 2016

(54) COMPARE PROFILES VISUAL CONTROL

(71) Applicant: LinkedIn Corporation, Mountain View, CA (US)

(72) Inventors: Ashley Woodman Hall, Menlo Park, CA (US); Anton Zadorozhnyy, Daly City, CA (US)

(21) Appl. No.: 14/673,666

(22) Filed: Mar. 30, 2015

(51) Int. Cl. G06Q 10/10; G06F 3/0484; G06Q 50/00

(52) U.S. Cl. CPC G06Q 10/1053; G06Q 50/01; G06F 3/04842

(57) ABSTRACT

A system for presenting goal-related insights—an insights module—may be configured determine a goal for a subject member represented by a subject profile in an on-line social network, identify a further profile that includes a feature indicative of achievement of the goal by a further member represented by the further profile, and cause presentation of a link to the further profile together with a compare visual control. The compare visual control is selectable to cause display of one or more features of the further profile. Activating the compare visual control may cause presentation of a further profile web page, such that the subject member can examine the further profile.

### TECHNICAL FIELD

This application relates to the technical fields of software and/or hardware technology and, in one example embodiment, to system and method for presenting goal-related insights in an on-line social network system and, specifically, to system and method for presenting a visual control selectable for viewing a profile of a member that have been identified as having achieved a particular goal.

### BACKGROUND

An on-line social network may be viewed as a platform to connect people in virtual space. An on-line social network may be a web-based platform, such as, e.g., a social networking web site, and may be accessed by a use via a web browser or via a mobile application provided on a mobile phone, a tablet, etc. An on-line social network may be a business-focused social network that is designed specifically for the business community, where registered members establish and document networks of people they know and trust professionally. Each registered member may be represented by a member profile. A member profile may be represented by one or more web pages, or a structured representation of the member's information in XML (Extensible Markup Language), JSON (JavaScript Object Notation) or similar format. A member's profile web page of a social networking web site may emphasize employment history and education of the associated member.

### BRIEF DESCRIPTION OF DRAWINGS

Embodiments of the present invention are illustrated by way of example and not limitation in the figures of the accompanying drawings, in which like reference numbers indicate similar elements and in which:

FIG. 1 is a diagrammatic representation of a network environment within which an example method and system for presenting goal-related insights to a member in an on-line social network system may be implemented;

FIG. 2 is block diagram of a system for presenting goal-related insights to a member in an on-line social network system, in accordance with one example embodiment;

FIG. 3 is a flow chart illustrating a method for presenting goal-related insights to a member in an on-line social network system, in accordance with an example embodiment;

FIG. 4 is a User Interface screen illustrating a profile compare visual control, in accordance with an example embodiment; and

FIG. 5 is a diagrammatic representation of an example machine in the form of a computer system within which a set of instructions, for causing the machine to perform any one or more of the methodologies discussed herein, may be executed.

### DETAILED DESCRIPTION

A method and system for presenting goal-related insights in an on-line social network system is described. In the following description, for purposes of explanation, numerous specific details are set forth in order to provide a thorough understanding of an embodiment of the present invention. It will be evident, however, to one skilled in the art that the present invention may be practiced without these specific details.

As used herein, the term “or” may be construed in either an inclusive or exclusive sense. Similarly, the term “exemplary” is merely to mean an example of something or an exemplar and not necessarily a preferred or ideal means of accomplishing a goal. Additionally, although various exemplary embodiments discussed below may utilize Java-based servers and related environments, the embodiments are given merely for clarity in disclosure. Thus, any type of server environment, including various system architectures, may employ various embodiments of the application-centric resources system and method described herein and is considered as being within a scope of the present invention.

For the purposes of this description the phrases “an on-line social networking application” and “an on-line social network system” may be referred to as and used interchangeably with the phrase “an on-line social network” or merely “a social network.” It will also be noted that an on-line social network may be any type of an on-line social network, such as, e.g., a professional network, an interest-based network, or any on-line network system that permits users to join as registered members. For the purposes of this description, registered members of an on-line social network may be referred to as simply members.

Each member of an on-line social network is represented by a member profile (also referred to as a profile of a member or simply a profile). A member profile may be associated with social links that indicate the member's connection to other members of the social network. A member profile may also include or be associated with comments or recommendations from other members of the on-line social network, with links to other network resources, such as, e.g., publications, etc. As mentioned above, an on-line social network system may be designed to allow registered members to establish and document networks of people they know and trust professionally. Any two members of a social network may indicate their mutual willingness to be “connected” in the context of the social network, in that they can view each other's profiles, profile recommendations and endorsements for each other and otherwise be in touch via the social network. Members that are connected in this way to a particular member may be referred to as that particular member's connections or as that particular member's network.

The profile information of a social network member may include personal information such as, e.g., the name of the member, current and previous geographic location of the member, current and previous employment information of the member, information related to education of the member, information about professional accomplishments of the member, publications, patents, etc. The profile information of a social network member may also include information about the member's professional skills. Information about a member's professional skills may be referred to as professional attributes. Professional attributes may be maintained in the on-line social network system and may be used in the member profiles to describe and/or highlight professional background of a member. Some examples of professional attributes (also referred to as merely attributes, for the purposes of this description) are strings representing professional skills that may be possessed by a member (e.g., “product management,” “patent prosecution,” “image processing,” etc.). Thus, a member profile may indicate that the member represented by the profile is holding himself out as possessing certain skills.

Members use various features and capabilities of an on-line social network to accomplish tasks such as maintaining contact with former and potential colleagues, searching for employment, recruiting, etc. While performing certain activities in an on-line social network, a member may have a certain task in mind (e.g., to obtain a list of software jobs in the Bay Area), as well as an overarching goal, which may be, e.g., professional advancement.

In order to facilitate a member's effort in utilizing an on-line social network to achieve professional advancement, a system is provided to identify the goal of a member being professional advancement and to present the member with an option to examine profiles of other members who have achieved the same goal.

An automated process to determine a goal that a member is trying to achieve and, based on that determined goal, present the member with an option to examine profiles of other members who have achieved the same goal may be referred to as insight presentation or a method for presenting goal-related insights. At a very high level tools and models used by a system for presenting goal-related insights are from the field of large scale data mining, natural language processing, and machine learning, using data that can be obtained via the subject on-line social network.

A system for presenting goal-related insights—an insights module—may be configured determine a goal for a subject member represented by a subject profile, identify a further profile that includes a feature indicative of achievement of the goal by a further member represented by the further profile, and cause presentation of a link to the further profile together with a so-called compare visual control. The compare visual control, in one example embodiment, is selectable to cause display of one or more features of the further profile. Activating the compare visual control may cause presentation of a further profile web page, such that the subject member can examine the further profile and, potentially, glean an insight into what helped the further member achieve their goal.

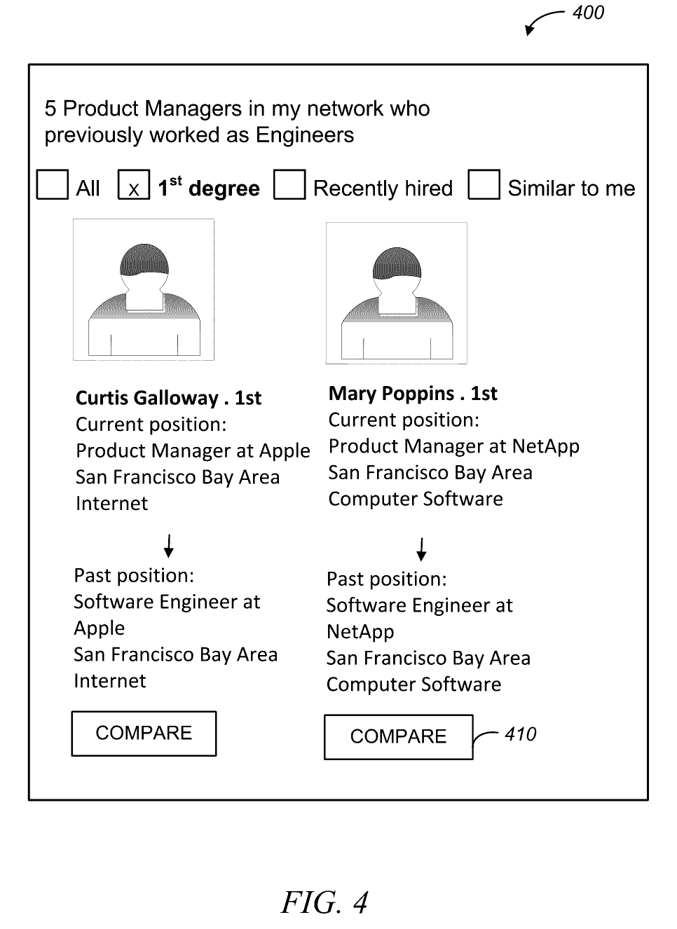

For example, the insights module may determine that the goal of a subject member is to transition from an engineering position to a position of a product manager. The insights module may then identify one or more profiles in the on-line social network that list the current position as a product manager and list a past position as an engineer. The on-line social network may then cause presentation of respective links to those identified profiles and also present a compare visual control next to each of the links. In one embodiment, activating the compare visual control permits the subject member to view the profile that indicates transition from an engineering position to a position of a product manager. In some embodiments, the presentation of an identified profile caused by activating of the compare visual control includes highlighting of one or more features in the identified profile that are lacking from the subject profile. For instance, the identified profile may list certain skills that are missing from the subject profile and that have been identified as relevant to the product manager position. Such skills would then be highlighted in the presentation of the identified profile to the subject member. An example User Interface screen illustrating a compare visual control is shown in FIG. 4, which is described further below.

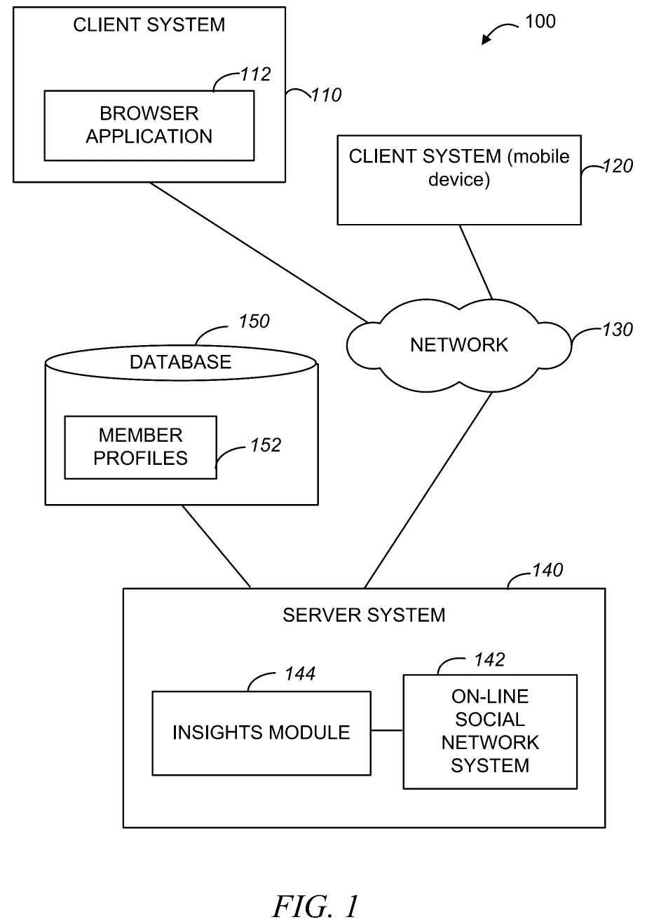

In one example embodiment, the insights module may utilize a so-called user understanding section of a member profile in order to determine a goal that the member is trying to achieve via the on-line social network. The user understanding section of a member profile representing a subject member may be filled out by monitoring user activities in the on-line social network, as well as activities of the user's connections and of other members that have been segmented into the same category as the subject member. Example categories, into which members may be segmented, are: student, career seeker, and career climber. A process where an insights module determines a goal of a subject member and causes presentation of relevant insights may be triggered by various triggering events, such as the subject member requesting a search in the on-line social network, an update to the profile of the subject member, a post by the subject member in the on-line social network, etc. An example insights module may be implemented in the context of a network environment 100 illustrated in FIG. 1.

As shown in FIG. 1, the network environment 100 may include client systems 110 and 120 and a server system 140. The client system 120 may be a mobile device, such as, e.g., a mobile phone or a tablet. The server system 140, in one example embodiment, may host an on-line social network system 142. As explained above, each member of an on-line social network is represented by a member profile that contains personal and professional information about the member and that may be associated with social links that indicate the member's connection to other member profiles in the on-line social network. Member profiles and related information may be stored in a database 150 as member profiles 152.

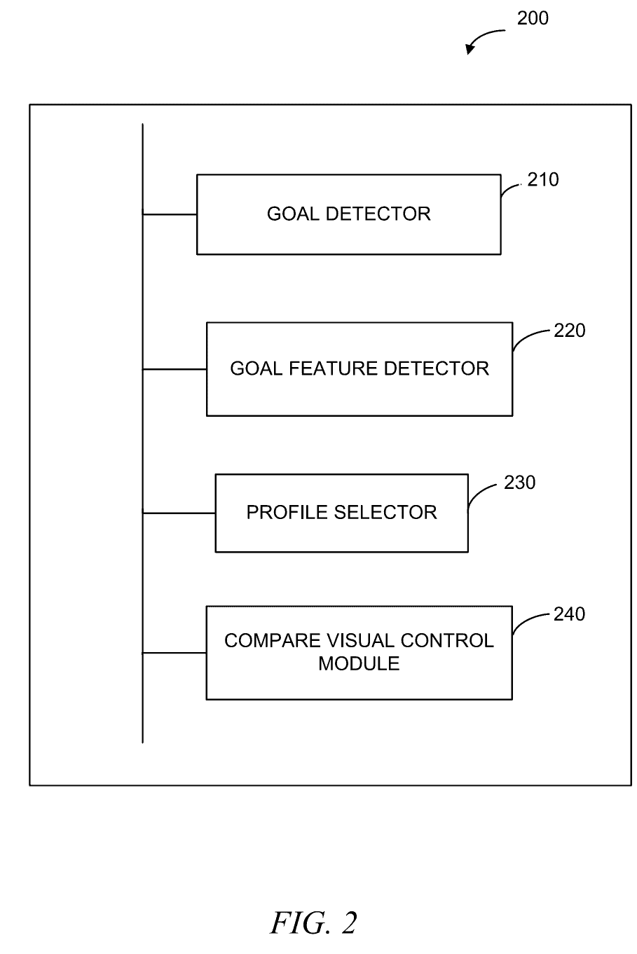

The client systems 110 and 120 may be capable of accessing the server system 140 via a communications network 130, utilizing, e.g., a browser application 112 executing on the client system 110, or a mobile application executing on the client system 120. The communications network 130 may be a public network (e.g., the Internet, a mobile communication network, or any other network capable of communicating digital data). As shown in FIG. 1, the server system 140 also hosts an insights module 144. The insights module 144 may be configured to determine a goal for a subject member represented by a subject profile, identify a further profile that includes a feature indicative of achievement of the goal by a further member represented by the further profile, and cause presentation of a link to the further profile together with a so-called compare visual control. The goal may be expressed by a combination of information from the subject profile and an action performed by the subject member in the on-line social network. For example, a goal may be expressed by information with respect to the member's current position in their profile and a search action that includes an identification of a different job position in the search string. As explained above, the compare visual control is selectable to cause display of one or more features of the further profile. Activating the compare visual control may cause presentation of a further profile web page, such that the subject member can examine the further profile and, potentially, glean an insight into what helped the further member achieve their goal. An example insights module 144 is illustrated in FIG. 2.

FIG. 2 is a block diagram of a system 200 for presenting goal-related insights to a member in an on-line social network system 142 of FIG. 1. As shown in FIG. 2, the system 200 includes a goal detector 210, a goal feature detector 220, a profile selector 230, and a compare visual control module 240. The goal detector 210 may be configured to determine a goal for a subject member represented by a subject profile in the on-line social network system 142 of FIG. 1. The determined goal may be expressed by a combination of information from the subject profile and an action performed by the subject member in the on-line social network system 142. In order to determine a goal for a subject member, the goal detector 210 may detect a trigger event indicative of a desired job position, determine that the subject profile includes an indication of a current job position that is distinct from the desired job position, and identify the goal as a transition from the current job position to the desired job position. The goal detector 210 may determine that the subject profile includes an indication of a current job position that is distinct from the desired job position, based on results of comparing a string representing the current job position to a string representing the desired job position. The trigger event may be a search request initiated by the subject member in the on-line social network system 142, a post initiated by the subject member in the on-line social network system 142, etc.

The goal feature detector 220 may be configured to determine a goal feature indicative of an achievement of the goal, based on the goal for the subject member. A goal feature may be, e.g., an indication that a current position of a further member listed in a further profile that represents the further member is the same as the desired job position determined for the subject member and that a previous job position of the further member listed in the further profile is the same as the current job position listed in the subject profile representing the subject member. The profile selector 230 may be configured to select, from profiles maintained in the on-line social network 142, a further profile having the goal feature. The further member represented by the further profile may be selected from the entire corpus of members in the on-line social network system 142 or only from those profiles that represent connections of the subject member.

The compare visual control module 240 may be configured to cause a compare visual control to be presented on a display device. As explained above the compare visual control is selectable to cause presentation of the further profile. An example compare visual control is represented by reference numeral 410 shown in FIG. 4. FIG. 4 is a User Interface screen 400 illustrating a profile compare visual control, in accordance with an example embodiment.

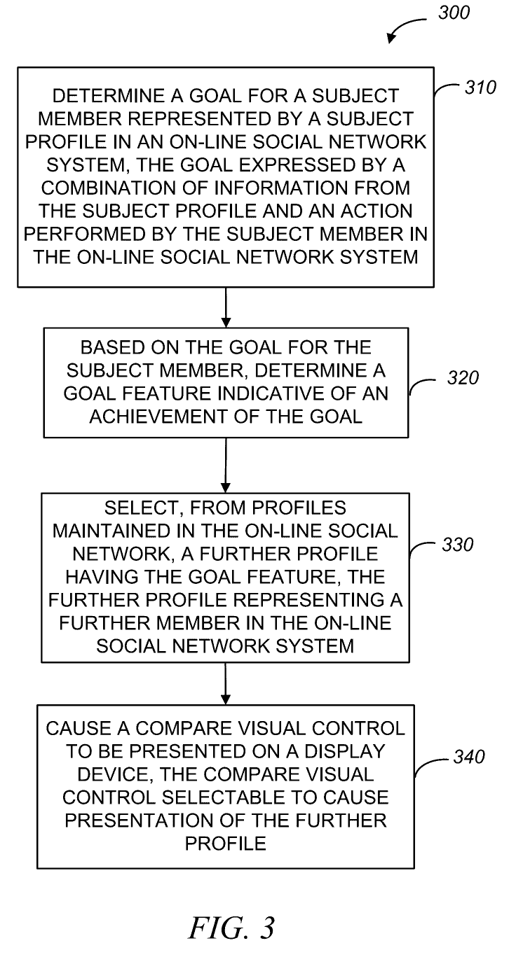

The compare visual control module 240 may be configured to detect selection of the compare visual control and present information from the further profile on a display device. In some embodiments, the compare visual control module 240 may be configured to highlight one or more skills listed in the further profile that are lacking from the subject profile. Some operations performed by the system 200 may be described with reference to FIG. 3.

FIG. 3 is a flow chart of a method 300 for presenting goal-related insights to a member in an on-line social network system 142 of FIG. 1. The method 300 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the server system 140 of FIG. 1 and, specifically, at the system 200 shown in FIG. 2.

As shown in FIG. 3, the method 300 commences at operation 310, when the goal detector 210 of FIG. 2 determines a goal for a subject member represented by a subject profile in the on-line social network system 142 of FIG. 1. As explained above, the determined goal may be expressed by a combination of information from the subject profile and an action performed by the subject member in the on-line social network system 142. At operation 320, the goal feature detector 220 of FIG. 2 determines a goal feature indicative of an achievement of the goal, based on the goal for the subject member. A goal feature may be, e.g., an indication that a current position of a further member listed in a further profile that represents the further member is the same as the desired job position determined for the subject member and that a previous job position of the further member listed in the further profile is the same as the current job position listed in the subject profile representing the subject member. At operation 330, the profile selector 230 of FIG. 2 selects, from profiles maintained in the on-line social network 142, a further profile having the goal feature. The further member represented by the further profile may be selected from the entire corpus of members in the on-line social network system 142 or only from those profiles that represent connections of the subject member. At operation 340, the compare visual control module 240 of FIG. 2 causes a compare visual control to be presented on a display device.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

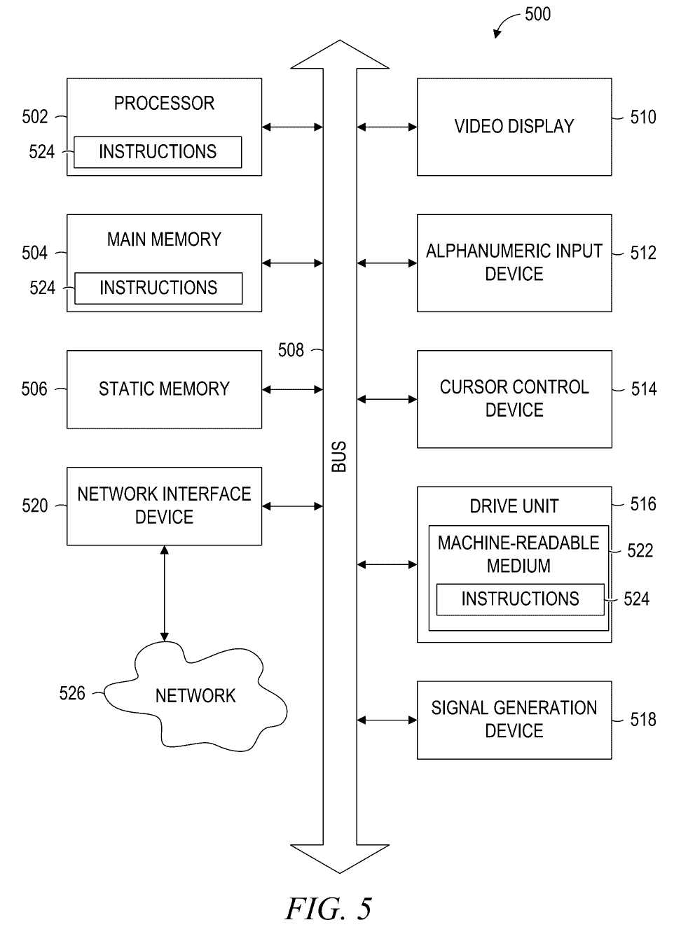

FIG. 5 is a diagrammatic representation of a machine in the example form of a computer system 500 within which a set of instructions, for causing the machine to perform any one or more of the methodologies discussed herein, may be executed. In alternative embodiments, the machine operates as a stand-alone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processor 502 (e.g., a central processing unit (CPU), a graphics processing unit (GPU) or both), a main memory 504 and a static memory 506, which communicate with each other via a bus 505. The computer system 500 may further include a video display unit 510 (e.g., a liquid crystal display (LCD) or a cathode ray tube (CRT)). The computer system 500 also includes an alpha-numeric input device 512 (e.g., a keyboard), a user interface (UI) navigation device 514 (e.g., a cursor control device), a disk drive unit 516, a signal generation device 518 (e.g., a speaker) and a network interface device 520.

The disk drive unit 516 includes a machine-readable medium 522 on which is stored one or more sets of instructions and data structures (e.g., software 524) embodying or utilized by any one or more of the methodologies or functions described herein. The software 524 may also reside, completely or at least partially, within the main memory 504 and/or within the processor 502 during execution thereof by the computer system 500, with the main memory 504 and the processor 502 also constituting machine-readable media.

The software 524 may further be transmitted or received over a network 526 via the network interface device 520 utilizing any one of a number of well-known transfer protocols (e.g., Hyper Text Transfer Protocol (HTTP)).

While the machine-readable medium 522 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing and encoding a set of instructions for execution by the machine and that cause the machine to perform any one or more of the methodologies of embodiments of the present invention, or that is capable of storing and encoding data structures utilized by or associated with such a set of instructions. The term “machine-readable medium” shall accordingly be taken to include, but not be limited to, solid-state memories, optical and magnetic media. Such media may also include, without limitation, hard disks, floppy disks, flash memory cards, digital video disks, random access memory (RAMs), read only memory (ROMs), and the like.

The embodiments described herein may be implemented in an operating environment comprising software installed on a computer, in hardware, or in a combination of software and hardware. Such embodiments of the inventive subject matter may be referred to herein, individually or collectively, by the term “invention” merely for convenience and without intending to voluntarily limit the scope of this application to any single invention or inventive concept if more than one is, in fact, disclosed.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

Thus, a method and system for presenting goal-related insights to a member in an on-line social network system has been described. Although embodiments have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense.

1. A computer-implemented method comprising:
in an on-line social network system, detecting a search request from a subject member represented by a subject profile in the on-line social network system;
from the search request, determining an identification of a desired job position;
determining that an identification of a current job position in the subject profile is distinct from the identification of the desired job position;
in response to the search request, selecting, from profiles maintained in the on-line social network, a further profile representing a further member in the on-line social network system, the further profile indicating a current position of the further member associated with the identification of the desired job position and a previous job position of the further member associated with the identification of the current job position; and
causing presentation on a display device information about the further member and a compare visual control, the compare visual control selectable to activate a link to a web page representing the further profile.

2. The method of claim 1, comprising determining, based on the search request, a goal of the subject member being
a transition from the current job position to the desired job position.

3. The method of claim 1, comprising comparing a string representing the current job position to a string representing the desired job position.

4. (canceled)

5. (canceled)

6. (canceled)

7. The method of claim 1, comprising:
detecting selection of the compare visual control, and
presenting information from the further profile on a display device.

8. The method of claim 7, wherein the presenting of the information from the further profile comprises highlighting one or more skills listed in the further profile that are lacking from the subject profile.

9. The method of claim 1, wherein the further profile represents the further member who is a connection of the subject member in the on-line social network system.

10. The method of claim 1, wherein the on-line social network system is a professional network system.

11. A computer-implemented system comprising:
a goal detector, implemented using at least one processor, to:
in an on-line social network system, detecting a search request from a subject member represented by a subject profile in the on-line social network system,
from the search request, determine an identification of a desired job position, and
determine that an identification of a current job position in the subject profile is distinct from the identification of the desired job position;
a profile selector, implemented using at least one processor, to select, in response to the search request, from profiles maintained in the on-line social network, a further profile representing a further member in the on-line social network system, the further profile indicating a current position of the further member associated with the identification of the desired job position and a previous job position of the further member associated with the identification of the current job position; and
a compare visual control module, implemented using at least one processor, to cause presentation on a display device information about the further member and a compare visual control, the compare visual control selectable to activate a link to a web page representing the further profile.

12. The system of claim 11, wherein the goal detector is to determine, based on the search request, a goal of the subject member being
a transition from the current job position to the desired job position.

13. The system of claim 11, wherein the goal detector is to compare a string representing the current job position to a string representing the desired job position.

14. (canceled)

15. (canceled)

16. (canceled)

17. The system of claim 11, wherein the compare visual control module is to:
detect selection of the compare visual control; and
present information from the further profile on a display device.

18. The system of claim 17, wherein the compare visual control module is to highlight one or more skills listed in the further profile that are lacking from the subject profile.

19. The system of claim 11, wherein the further profile represents the further member who is a connection of the subject member in the on-line social network system.

20. A machine-readable non-transitory storage medium having instruction data executable by a machine to cause the machine to perform operations comprising:
in an on-line social network system, detecting a search request from a subject member represented by a subject profile in the on-line social network system;
from the search request, determining an identification of a desired job position;
determining that an identification of a current job position in the subject profile is distinct from the identification of the desired job position;
in response to the search request, selecting, from profiles maintained in the on-line social network, a further profile representing a further member in the on-line social network system, the further profile indicating a current position of the further member associated with the identification of the desired job position and a previous job position of the further member associated with the identification of the current job position; and
causing presentation on a display device information about the further member and a compare visual control, the compare visual control selectable to activate a link to a web page representing the further profile.
